(19) United States
(12) Patent Application Publication
(10) Pub. No.: US 2026/0316033 A1
(43) Pub. Date: Oct. 15, 2026

(54) PRODUCTION OF POLYHEDRON MICROGELS THROUGH BUOYANCY FORCES

(71) Applicant: The Regents of The University of Michigan, Ann Arbor, MI (US)

(72) Inventors: Yoke Qi HO, Ann Arbor, MI (US); Sasha Cai LESHER-PEREZ, Ann Arbor, MI (US)

(73) Assignee: The Regents of The University of Michigan, Ann Arbor, MI (US)

(21) Appl. No.: 19/644,163

(22) Filed: Apr. 10, 2026

Related U.S. Application Data
(60) Provisional application No. 63/786,736, filed on Apr. 10, 2025.

(51) Int. Cl. B01J 13/00

(52) U.S. Cl. CPC B01J 13/0065

(57) ABSTRACT

A microparticle is provided defining a polyhedral shape and having a polymeric precursor and a crosslinking agent capable of undergoing a gelation reaction to form a cross-linked polymeric microgel. Methods for generating microparticles having a polyhedral shape for a microgel include generating a plurality of microdroplets by introducing a precursor solution into an inlet of a component that comprises a plurality of channels in fluid communication with a plurality of outlets. The precursor solution flows radially through the component from the inlet to the plurality of outlets and passing into a fluid contained in a fluid reservoir to generate a plurality of microdroplets, which transition into a plurality of microparticles having a polyhedral shape. A density of the precursor solution is less than a density of the fluid and one or more surfactants are present.

### CROSS-REFERENCE TO RELATED APPLICATIONS

This application claims the benefit of U.S. Provisional Application No. 63/786,736, filed Apr. 10, 2025. The entire disclosure of the above application is incorporated herein by reference.

### FIELD

The present disclosure relates to microparticles defining a polyhedral shape and methods for batch production of polyhedron microgels through buoyancy forces.

### BACKGROUND

This section provides background information related to the present disclosure which is not necessarily prior art.

Microgels may be formed of small particles (e.g., colloids) having at least one dimension on a microscale. Microgels are typically formed of three-dimensional networks of cross-linked polymer chains in a semi-solid or solid phase. Microgels, and their composite structures of granular hydrogels, have been gaining popularity due to the combined benefit of being injectable and instantaneously achieving microscale porosity. Spherical granular microgel systems have demonstrated promise in tissue engineering and regenerative medicine but are shape-limited because generating spherical droplets is more energetically favorable. Some granular gels with distinct geometries (e.g., crescent-shaped rod microgels) have been made and tested, showing different cellular responses and thus creating new pathways to investigate geometric effects on biological behavior. Current methods to generate non-spherical microgel geometries have relatively low throughput (e.g., lower than 1 mL/hr.) and particle polydispersity, relying on techniques like photolithography, micromolding, and mechanical fragmentation to generate non-spherical microgels. It would be desirable to find new methods of forming non-spherical microgels that are not limited by low throughput and non-uniform production. Further, techniques that provide scalable production and precise geometric control would surmount current challenges for evaluating the geometric properties of microgels.

### SUMMARY

This section provides a general summary of the disclosure, and is not a comprehensive disclosure of its full scope or all of its features.

In certain aspects, the present disclosure relates to microparticle defining a polyhedral shape. The microparticle comprises a polymeric precursor and a crosslinking agent capable of undergoing a gelation reaction to form a cross-linked polymeric microgel.

In one aspect, the polymeric precursor is of a polymeric backbone selected from the group consisting of: hyaluronic acid, polyalkylene glycol, such as polyethylene glycol, alginate, gelatin, trehalose, and combinations thereof.

In one aspect, the polymeric precursor is selected from the group consisting of: hyaluronic acid-norbornene, polyethylene glycol-norbornene, polyethylene glycol-maleimide, polyethylene glycol-di-acrylate, and combinations thereof.

In one aspect, the crosslinking agent comprises a thiol group.

In one aspect, the crosslinking agent is selected from the group consisting of: a dithiothreitol crosslinking agent, a polyethylene-glycol dithiol crosslinking agent, an enzymatically degradable plasmin-sensitive YKNS crosslinking agent, and combinations thereof.

In one aspect, the polymeric precursor further comprises a functional group selected from the group consisting of: norbornene, maleimide, cyclononane, bicyclononyne, dibenzocyclooctyne (DBCO), dibenzoazacyclooctyne (DIBAC), vinyl sulfone, azide, tetrazine, acrylate, methacrylate, and combinations thereof.

In one aspect, the microparticle has an average particle size of greater than or equal to about 135 micrometers to less than or equal to about 1,000 micrometers.

In one aspect, the polyhedral shape is selected from the group consisting of: rectangular prism, cube, pyramid, tetrahedron, pentahedron, hexahedron, heptahedron, octahedron, decahedron, undecahedron, dodecahedron, icosahedrons, prismatoids, and combinations thereof.

In certain further aspects, the present disclosure relates to a method for generating microparticles having a polyhedral shape for a microgel. The method may comprise generating a plurality of microdroplets. The generating may occur by introducing a precursor solution into an inlet of a component that comprises a plurality of channels in fluid communication with a plurality of outlets. The precursor solution flows radially through the component from the inlet to the plurality of outlets and passes into a fluid contained in a fluid reservoir to generate a plurality of microdroplets that transition into a plurality of microparticles having a polyhedral shape. The precursor solution has a first density, the fluid has a second density distinct from the first density, and at least one of the precursor solution or fluid comprises a surfactant.

In one aspect, the method further comprises conducting a gelation process on the plurality of microparticles in a receptacle to form a microgel.

In one aspect, the plurality of microdroplets are collected in a receptacle to define a plurality of distinct layers of the microdroplets.

In one aspect, the precursor solution comprises a crosslinker comprising a thiol group.

In one aspect, the precursor solution comprises a polymeric precursor of a polymeric backbone selected from the group consisting of: hyaluronic acid, polyalkylene glycol, such as polyethylene glycol, alginate, gelatin, trehalose, and combinations thereof. The polymeric backbone further has a functional group selected from the group consisting of: further comprises a functional group or moiety selected from the group consisting of: norbornene, maleimide, cyclononane, bicyclononyne, dibenzocyclooctyne (DBCO), dibenzoazacyclooctyne (DIBAC), vinyl sulfone, azide, tetrazine, acrylate, methacrylate, and combinations thereof.

In one aspect, the precursor solution comprises a polymeric precursor selected from the group consisting of: hyaluronic acid-norbornene, polyethylene glycol-norbornene, polyethylene glycol-maleimide, polyethylene glycol-di-acrylate, and combinations thereof.

In one aspect, the plurality of microdroplets has an average diameter of greater than or equal to about 135 micrometers.

In one aspect, the plurality of microparticles has an average particle size of greater than or equal to about 135 micrometers to less than or equal to about 1,000 micrometers.

In one aspect, the second density of the fluid is greater than the first density of the precursor solution and the fluid comprises an oil.

In one aspect, the polyhedral shape is selected from the group consisting of: rectangular prism, cube, pyramid, tetrahedron, pentahedron, hexahedron, heptahedron, octahedron, decahedron, undecahedron, dodecahedron, icosahedrons, prismatoids, and combinations thereof.

In one aspect, the surfactant is a nonionic surfactant.

In one aspect, after the generating, the method further comprises centrifuging the plurality of microdroplets to facilitate the transition to the plurality of microparticles having a polyhedral shape.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1E show five images of various polyhedral microgel particles formed in accordance with certain aspects of the present disclosure. FIG. 1A shows post-droplet generation of 15 wt. % 4-arm poly(ethylene glycol) norbornene (PEG4NB) gel droplets. Fluorescent and bright-field images of post-swelled microgels (FIGS. 1B and 1C) show generation of polyhedral particles. FIGS. 1D and 1E show a shape transition for microparticles, where spherical droplets (approximately 400 micrometers (μm) diameter) transition to polyhedrons as packing layers increase from 2 layers (FIG. 1D) to 8 layers (FIG. 1E) in accordance with certain aspects of the present disclosure.

FIGS. 2A-2D. FIG. 2A shows a schematic of a portion of a microfluidic system for microdroplet generation in accordance with certain aspects of the present disclosure. FIG. 2B shows a detailed view of an outlet region of a microfluidic channel of the microfluidic system of FIG. 2A. FIG. 2C shows an outlet region of a microfluidic channel having multiple branches forming multiple microfluidic channel outlets. FIG. 2D shows an example of buoyancy-driven droplet generation in a microfluidic droplet generator device to create microparticles in accordance with certain aspects of the present disclosure, where layers of droplets transition to microdroplets having polyhedral shapes. An image of a plurality of polyhedral microparticles thus formed is shown, with a scale bar of 500 micrometers.

FIG. 3 shows an energy balance between buoyancy and interfacial tension.

FIGS. 4A-4B show energy differences due to droplet size (FIG. 4A) and layer numbers (FIG. 4B) at a cavity height of 4 mm. FIG. 4A shows droplet diameter (micrometers) versus a change in energy (ΔE) in Joules. FIG. 4B shows a number of layers versus a change in energy (ΔE) in Joules.

FIGS. 5A-5B shows images reflecting an influence of droplet layers and droplet size in shape transition to create polyhedral particles. FIGS. 5A and 5B each have a scale bar of 500 micrometers, while FIG. 5C has a scale bar of 1,000 micrometers.

FIG. 6 shows a process for generating polyhedral microgels from spherical droplets by using a centrifuge according to certain aspects of the present disclosure.

FIGS. 7A-7D show generation of polyhedral microgels across sizes and formation into microporous annealed microgel (MAP) gel, including microgels comprising polyhedral microparticles prepared according to certain aspects of the present disclosure. FIG. 7A shows droplet diameter distribution for large, medium, and small spherical droplets (mean diameters: 480 micrometer (m) large, 282 micrometers (μm) medium, 135 micrometers (μm) small; with respective PDI: polydispersity index indicated). FIG. 7B shows representative brightfield images of polyhedral microparticles formed from microdroplets of each size indicated in FIG. 7A. FIG. 7C shows comparative high-volume production from spherical droplets versus polyhedral droplets. FIG. 7D shows comparative confocal z-stack 3D-reconstructed images that compare a MAP gel formed from polyhedral microgels versus spherical microgels.

FIGS. 8A-8C show polyhedral microgels formed in accordance with certain aspects of the present disclosure alter microporous annealed microgel (MAP) scaffold pore architecture, as compared to spherical microgels. FIG. 8A shows a comparison of a spherical microdroplet-based MAP scaffold versus a polyhedral microparticle-based MAP scaffold, where the scale bars are 100 micrometers. FIG. 8B shows schematics of the comparative pores in MAP scaffolds created in IMARIS™ software. FIG. 8C shows comparative values for porosity (%), pore size distribution (micrometers-squared), and pore count for spherical versus polyhedral MAPs.

FIGS. 9A-9E show rheological comparison of spherical and polyhedral scaffolds formed in accordance with certain aspects of the present disclosure. FIGS. 9A-9B show measured storage modulus (G′) for spherical and polyhedral scaffolds under annealed (MAP) and non-annealed states (n=3, mean±s.d.). FIGS. 9C and 9D show strain recovery of spheres versus polyhedra of non-annealed scaffold. FIG. 9C shows oscillation strain (%) versus storage modulus and loss modulus (G′ G″ (Pa). FIG. 9D shows thixotropy test (non-annealed) that showed comparable strain recovery for both shapes, supporting injectability, while polyhedral scaffolds remained stiffer overall through storage modulus and loss modulus (G′ G″ (Pa)). FIG. 9E shows viscosity measured for non-annealed scaffolds as a function of shear rate to assess shear-thinning behavior relevant to injectability. p*<0.05, ns=not significant.

FIGS. 10A-10C show how microgel shape influences NHCF-V cell morphology and cell accumulation in MAP scaffolds, comparing spherical and polyhedral scaffolds formed in accordance with certain aspects of the present disclosure. FIG. 10A shows fibroblasts grown in a spherical MAP (left) versus a polyhedral MAP hydrogel (right). FIG. 10B shows days of culture in vitro versus cell count in the comparative spherical and polyhedral hydrogels. FIG. 10C shows representative images in comparative spherical and polyhedral MAPs across culture time points (Days 3, 5, 7, and 12). Scale bars are 100 μm.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure pertains to forming a microparticle comprising a polymeric precursor having a polyhedral morphology or shape. By polyhedral, it is meant a non-round (not spherical, oval, or the like), but rather a shape defining a three-dimensional polyhedral or polyhedron structure having a plurality of flat faces that are interconnected at joints or corners. By way of example, such polyhedral shapes may include rectangular prisms, including a cube having congruent square faces, tetrahedrons, pyramids, tetrahedrons, pentahedrons, hexahedrons, which may include rectangular prisms or cubes or define other shapes with six faces, heptahedrons, octahedrons, decahedrons, undecahedrons, dodecahedrons, prismatoids, and the like.

The microparticles having a polyhedral shape can thus form polyhedron microgels or polyhedral-based microgels. The significance of making polyhedron microgels is the creation of new microgel scaffold structures from distinct geometries to study different cellular responses, creating new pathways to investigate geometric effects on biological behavior.

In certain aspects, the particle is a microparticle defining a polyhedral shape. By microparticle, it is meant that the particle has at least one dimension on a microscale. The microparticles formed may have a “microscale,” referring to a structure having at least one dimension (e.g., height, width, length) that is less than or equal to about 1,000 micrometers (μm), optionally less than or equal to about 900 micrometers (μm), optionally less than or equal to about 800 micrometers (μm), optionally less than or equal to about 700 micrometers (μm), optionally less than or equal to about 600 micrometers (μm), optionally less than or equal to about 500 micrometers (μm), and in certain aspects, optionally less than or equal to about 400 micrometers.

The microparticle may be formed of a polymeric precursor and a crosslinking agent capable of undergoing a gelation reaction (or annealing or crosslinking) to form a cross-linked polymeric microgel. The polymeric precursor may thus have at least one functional group incorporated into a monomer, oligomer, or polymer that can react with the crosslinking agent. The polymeric precursor may further comprise a functional group selected from the group consisting of: further comprises a functional group or moiety selected from the group consisting of: norbornene, maleimide, cyclononane, bicyclononyne, dibenzocyclooctyne (DBCO), dibenzoazacyclooctyne (DIBAC), vinyl sulfone, azide, tetrazine, acrylate, methacrylate, and combinations thereof. Norbornene may define a dibenzocyclooctyne (DBCO) that can react with a thiol or azide group on a crosslinker or other moiety.

In certain aspects, a polymeric precursor of a polymeric backbone may be selected from the group consisting of: hyaluronic acid, polyalkylene glycol (or polyalkylene oxide), such as polyethylene glycol (or polyethylene oxide (PEO)), alginate, gelatin, trehalose, and combinations thereof. In certain aspects, the polymeric precursor backbone may be functionalized and thus further have a cross-linking or functional group selected from the group consisting of: norbornene, maleimide, cyclononane, bicyclononyne, dibenzocyclooctyne (DBCO), dibenzoazacyclooctyne (DIBAC), vinyl sulfone, azide, tetrazine, acrylate, methacrylate, and combinations thereof. In certain aspects, the functional or reactive group is thus capable of reacting with the crosslinking agent during the gelation reaction. In certain other aspects, the polymeric precursor may be capable of self-crosslinking, for example, alginate can ionically cross-link. In other variations, the polymeric precursor may be trehalose and may dehydrate, for example, for DNA storage or freezing for cell preservation. Specific examples of suitable polymeric precursors, which may optionally be functionalized with a functional group for cross-linking, may be selected from the group consisting of: hyaluronic acid-norbornene, polyethylene glycol-norbornene, polyethylene glycol-bicyclononyne, polyethylene glycol-tetrabicyclononyne, polyethylene glycol-maleimide, polyethylene glycol-di-acrylate, polyethylene glycol-tetra-acrylate, gelatin-norbornene, gelatin-methacrylate, alginate, trehalose, and combinations thereof. In certain variations, an average molecular weight of the polymeric backbone may be greater than or equal to about 10 kDa to less than or equal to about 90 kDa, by way of example. In certain variations, the polymeric precursor comprises polyethylene glycol (PEG)-norbornene having an average molecular weight of 20 kDa or 40 kDa.

In certain aspects, the microparticle comprises a crosslinking agent, which may comprise a thiol group. In certain variations, the crosslinking agent may be degradable, for example, by enzymes or hydrolytic degradation. In certain variations, by way of example, a crosslinker is selected from the group consisting of: a dithiothreitol crosslinking agent, a polyethylene-glycol dithiol crosslinking agent, an enzymatically degradable plasmin-sensitive peptides with GCYKNSGCYKNSCG (YKNS) crosslinking agent, a hydrolytically degradable ethylene glycol bis(mercaptoacetate) (EGBMA) crosslinking agent, and combinations thereof. In some further aspects, the crosslinking agent is degradable and is one or more an enzymatically degradable plasmin-sensitive YKNS crosslinking agent or a hydrolytically degradable EGBMA crosslinking agent. Suitable glycol dithiol may have an average molecular weight ranging from 1,800 to 3,500. The precursor may also include a catalyst or initiator for initiating the crosslinking or gelation reaction. One suitable example of a photoinitiator is lithium phenyl-2,4,6-trimethylbenzoylphosphinate (LAP).

To conduct a gelation reaction to form a microgel matrix, the microparticles may be exposed to a source of energy and/or heat to promote crosslinking and/or a gelation reaction. For example, the microparticles may be exposed to light, like actinic radiation, such as ultraviolet (UV) light. In certain other variations, electron beam (e-beam) crosslinking may be employed. In yet other variations, a pH of the fluid or environment in which the microparticles are disposed may be modified for promoting crosslinking and gelation.

In certain variations, the present disclosure contemplates the use of one or more of the following polymer backbones: hyaluronic acid functionalized with norbornene (e.g., a UV photoinitiated, thiol-ene reaction), polyethylene glycol (PEG) with norbornene (e.g., a UV photoinitiated, thiol-ene reaction), PEG functionalized with bicyclononyne (e.g., strain-promoted azide-alkyne cycloaddition reaction), PEG functionalized with acrylate, e.g., PEG-diacrylate or tetra-acrylate (e.g., UV photoinitiated, free radical polymerization), PEG functionalized with maleimide (e.g., Michael addition, maleimide-thiol reaction), gelatin functionalized with methacrylate (e.g., UV photoinitiated, free radical polymerization), gelatin functionalized with norbornene (e.g., UV photoinitiated, thiol-ene reaction), alginate (e.g., ionic crosslinking), or trehalose (e.g., dehydration).

By way of example, Table 1 below shows examples of polymeric precursors suitable for use in accordance with the present disclosure.

TABLE 1

| | Molecular | Functional | Concentration | Concentration | Crosslinker | |
|---|---|---|---|---|---|---|
| Backbone | Weight of | Group for | of Backbone | of Backbone | concentration | Mechanism |
| Composition | Backbone | Gelation | (in mM) | (in wt. %) | (mM) | of gelation |
| Hyaluronic Acid - | 90 kDa | Norbornene | 0.110; 0.210; | 1.0; 2.0; 3.0 | 1.22; 2.33; | Photogelation |
| Norbornene | | | 0.320 | | 3.56 | |
| Polyethylene Glycol | 10 kDa | Norbornene | 5 | 5 | 9.8 | Photogelation |
| (4 arm) - Norbornene | | | | | | |
| Polyethylene Glycol | 20 kDa | Norbornene | 5.0; 7.5; 10.0; | 10.0; 15.0; | 9.0; 13.5; 18.0 | Photogelation |
| (4 arm) - Norbornene | | | | 20.0 | | |
| Polyethylene Glycol | 40 kDa | Norbornene | 1.5; 2.0; 2.5; | 6.0; 8.0; 10.0; | 2.4; 3.2; 4.0 | Photogelation |
| (8 arm) - Norbornene | | | | | | |

The plurality of microparticles formed may have an average particle size of greater than or equal to about 15 micrometers to less than or equal to about 1,000 micrometers. In certain aspects, an average particle size is greater than or equal to about 135 micrometers to less than or equal to about 1,000 micrometers, for example, greater than or equal to about 400 micrometers to less than or equal to about 750 micrometers.

In certain variations, the microparticle or solution that forms the microparticle may have a surface active agent or surfactant. The presence of the surface active agents as the microparticle is being formed can help with particle shape formation, as well as to minimize or prevent agglomeration and coalescing of the microdroplets/microparticles, as they are formed. In certain variations, the polymer or gel precursor may also comprise a surface active agent.

In certain variations, a suitable surfactant is a nonionic surfactant. Nonionic surfactants include compounds produced by the condensation of alkylene oxides (especially ethylene oxide) with an organic hydrophobic compound, which may be aliphatic or alkylaromatic in nature. Other suitable nonionic surfactants include poly(oxyethylene)-poly(oxypropylene) block copolymers, especially triblock polymers of this type with two blocks of poly(oxyethylene) and one block of poly(oxypropylene). Such copolymers are known commercially by the non-proprietary name of poloxamers, the name being used in conjunction with a numeric suffix to designate the individual identification of each copolymer. Poloxamers may have varying contents of ethylene oxide and propylene oxide, leading to a wide range of chemical structures and molecular weights. One suitable non-ionic surfactant is commercially available as Pluronic® F108 from BASF Corporation, which is a nonionic difunctional block copolymer surfactant terminating in primary hydroxyl groups.

In various aspects, the present disclosure provides a methodology for generating polyhedral microgels using buoyancy forces and droplet deformation through a simple, high-throughput, and scalable generation. In certain aspects, a precursor solution has a first density and is processed in a microfluidic droplet generator component that is in fluid communication with a fluid in a static bath. The fluid has a second density distinct from the first density. In certain aspects, the second density of the fluid is greater than the first density. The fluid may be an oil, such as a fluorinated oil. One suitable fluorinated oil is commercially available as NOVEC™ 7500 from 3M. Other high density oils are also contemplated. Further, the fluid and/or precursor solution may comprise one or more surface active agents.

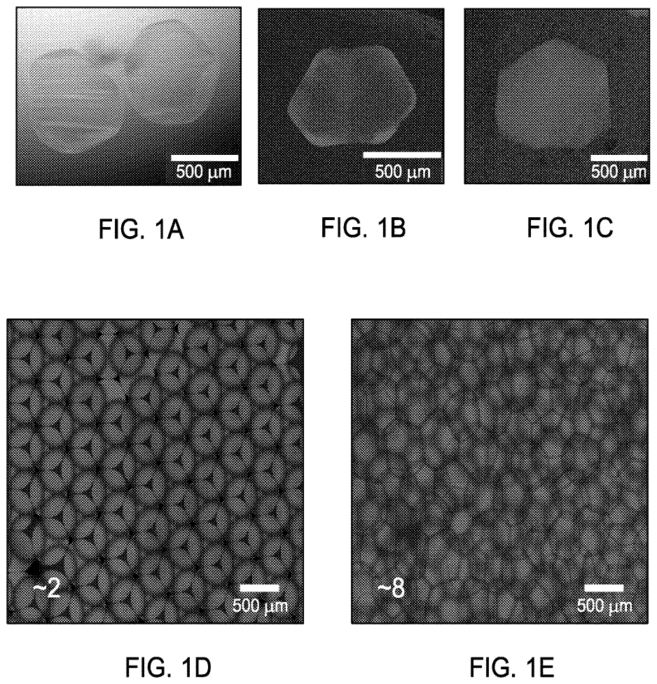

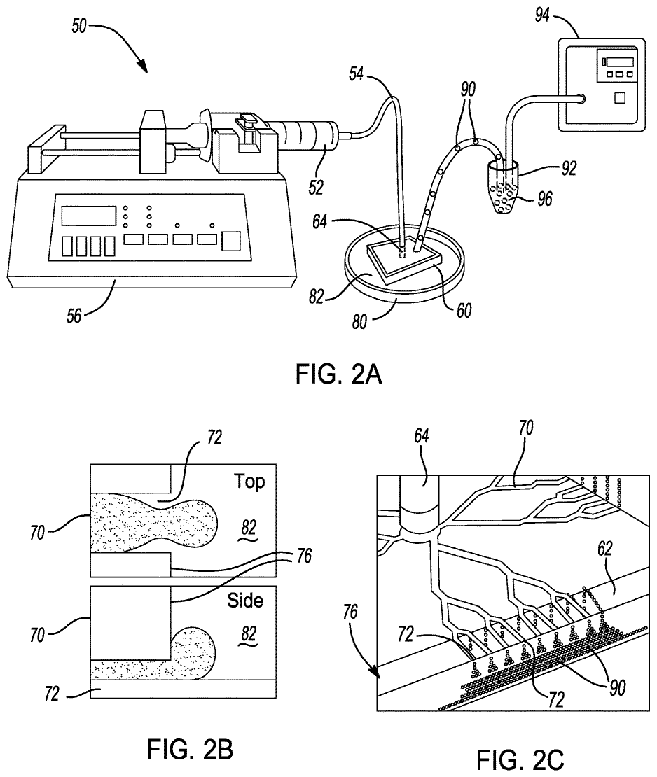

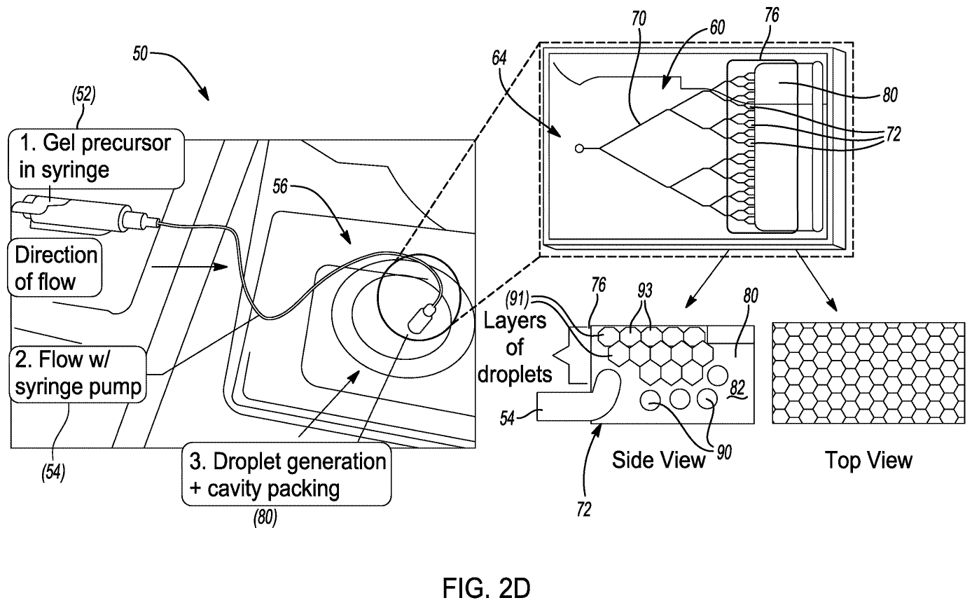

FIGS. 2A-2D show variations of a microfluidic system including a microfluidic device for forming a plurality of droplets, such as microdroplets, which may also be considered to be microparticles, that may be further processed, for example, first by packing them into layers to facilitate a transition to polyhedral shapes. This may be followed by subjecting the polyhedral microparticles to a cross-linking or gelation reaction to become a microgel. The microfluidic system may include a microfluidic device for generating microdroplets for forming a microgel and is further described in co-pending and co-owned PCT Application No. PCT/US2026/23068 filed on Apr. 9, 2026 to Sasha Cai Lesher Perez, et al. entitled “BUOYANCY-CLEARED MICROFLUIDIC PLATFORM FOR RAPID AND UNIFORM DROPLET GENERATION AND MICROGELS FOR CELL AND TISSUE ENCAPSULATION,” the relevant portions of which are hereby incorporated by reference. For example, a microfluidic system 50 for generating microdroplets for a microgel includes a source of polymer or gel precursor 52 (as shown, the gel precursor is contained in a syringe as part of an automated syringe pump, although the syringe may be used manually to transfer the gel precursor, or other fluid transport systems may be used). The source of gel precursor 52 may feed a precursor stream 54. The microfluidic system 50 includes at least one pressure-generating component, which may be a pump, pneumatically-driven device or other automated pressure generation device or a manual-operation device, such as a manually operated syringe device. The pressure-generating component shown in FIG. 1A is an automated syringe pump 56. The syringe pump 56 pumps the precursor stream 54 so that it is introduced to a microfluidic fluid distribution or droplet generator component 60 that includes at least one layer 62. In certain aspects, the at least one layer is a first layer. In further variations, the droplet generator may have multiple layers in addition to the first layer. The precursor stream 54 is introduced into an inlet 64 (which may be centrally disposed) of the at least one layer 62 of the droplet generator component 60.

The inlet 64 may receive the precursor stream 54, which may be a fluid/liquid material prepared upstream (e.g., prior to being introduced into the source of gel precursor 52) and introduced to the inlet 64. In certain variations, the precursor stream 54 may comprise a liquid devoid of cells, while in other variations, the precursor stream 54 optionally further includes cells or tissue. The droplet generator component 60 also has a plurality of channels 70 in fluid communication with the inlet 64 and a plurality of outlets 72. In the variation shown, the outlets 72 are radially outward from the centrally disposed inlet 64. The outlets 72 may be disposed near a peripheral edge 76 of the droplet generator component 60. In this manner, the precursor material flows radially (outward) from the inlet 64 within the channels 70 of the at least one layer 62 of the droplet generator component 60. The channels 70 may have one or more branches formed therein, such that a first channel may be fluidly coupled to the inlet 64; however, they may be branched at least once and optionally multiple times (as shown, at least six times) and thus fluidly coupled to multiple outlets 72. In certain variations, the droplet generator component 60 may have greater than or equal to about 32 outlets, for example, optionally greater than or equal to about 32 outlets to less than or equal to about 2,048 outlets, optionally greater than or equal to about 32 outlets to less than or equal to about 1,024 outlets, and in certain aspects, optionally greater than or equal to about 32 outlets to less than or equal to about 512 outlets. In certain aspects, the droplet generator component 20 may have 32 outlets or optionally 512 outlets or optionally 1,024 outlets or optionally 2,048 outlets.

The channels 70 may be a microfluidic channel. A microfluidic channel 70 is formed in or on a substrate that has a cross-sectional area and volume sufficient to permit receiving, storing, and/or transferring materials, including fluids. Fluids include liquids, gases, vapors, and the like. Thus, a microchannel may have dimensions such that the length of the structure forms the greatest dimension, for example, a groove (an open shape) or channel (a structurally closed geometry). In certain variations, the microfluidic channels 70 may be fully enclosed structures defining a void region that permits fluid communication there through, as described further herein. The microfluidic channels 70 may have a variety of cross-sectional shapes, including circular, round, or oval (forming a tube or cylindrical shape), rectangular, including square, and the like.

The microfluidic system 60 further includes at least one fluid reservoir 80 for generating microdroplets for a microgel. More specifically, the microfluidic droplet generator component 60 may be at least partially disposed in the fluid reservoir 80, which may contain a fluid 82 that may be a static bath. In one variation, the fluid 82 may comprise 0.4 wt. % Picosurf® surfactant (a proprietary biocompatible surfactant commercially available from Sphere Fluidics) in Novec™ 7500 oil. At least a portion of the droplet generator component 60 contacts the fluid 82 bath. The fluid reservoir 80 of the microfluidic system 50 serves as the static bath and is configured to hold a fluid 82 having a distinct density from the precursor material. The second fluid in the reservoir 80 may be considered to be a continuous phase, while the first fluid in the precursor stream 54 may be considered to be a dispersed phase. As noted above, at least a portion of the droplet generator component 60 is disposed within or adjacent to the fluid reservoir 80, so that the plurality of outlets 72 are in fluid communication with the fluid 82 in the fluid reservoir 80. In this manner, the precursor stream/solution 54 exits the plurality of outlets 72 and enters the fluid 82 in the fluid reservoir 80 to form a plurality of microdroplets 90. As shown in FIGS. 2A, 2B, and 2D, the outlet 72 of the microchannel 70 faciliatates droplet 90 formation, which in this variation, can float to an upper region of the fluid reservoir 80 while in the fluid 82 having a lower density and being more buoyant.

FIG. 2D shows a plurality of microdroplets 90 formed in such microfluidic devices in microfluidic systems, which form a plurality of layers 91. As the microdroplets 90 form the dense layers 91, they transition shape to form polyhedral microdroplets 93. The polyhedral microdroplets 93 may be further collected from the reservoir 80. The microfluidic system 60 includes a collection vessel 92 that may be connected to a source of UV radiation 94 or other components for faciliating gelation or cross-linking reactions of a plurality of polyhedral microdroplets 93 to form a microgel 96 (e.g., a granular or porous hydrogel).

FIG. 2D shows one example of buoyancy-driven droplet generation that occurs at 1-5 mL/hr. through 32 microchannels (125 μm height×300 μm width). Droplets are pinched off using 0.4 wt. % Picosurf® surfactant (a proprietary biocompatible surfactant commercially available from Sphere Fluidics) in Novec™ 7500 oil. Density differences with Novec™ 7500 causes droplets to float into a static reservoir (4 mm H×40 mm L×13 mm W). Increasing droplet volume and buoyancy within the closed cavity confines droplets, forcing them to compress into sharp-edged particles. As shown, the spherical microdroplets define multiple layers 91 and transition from spherical microdroplets 90 into microdroplets having polyhedral shapes 93.

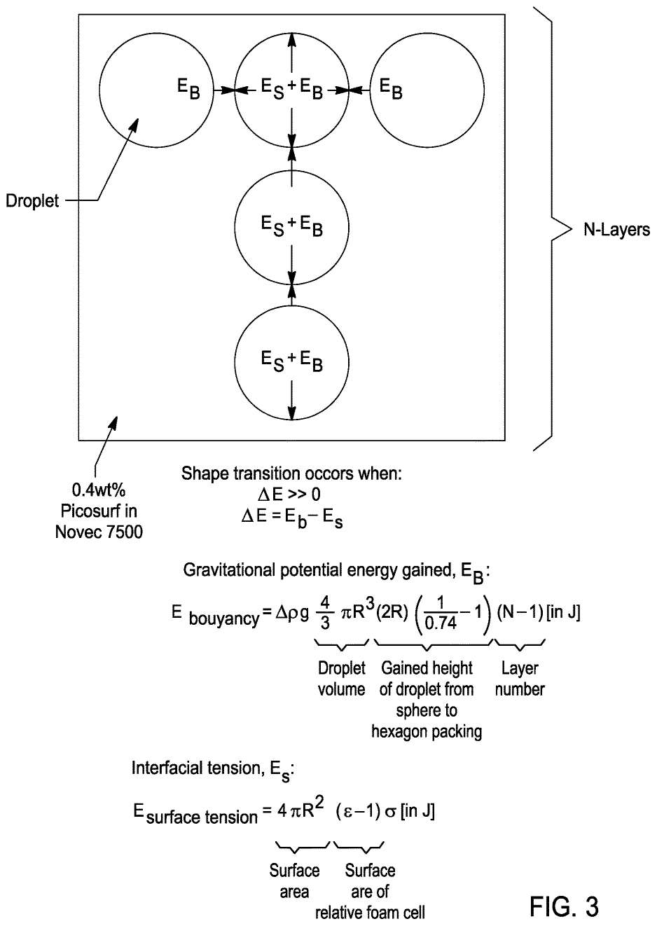

FIG. 3 shows an energy balance between buoyancy and interfacial tension at the droplet interface, which demonstrates the shape transition to the polyhedral particle. This relates to droplet size and the number of layers forming polyhedral particles. N-Layers are shown. Calculations for gravitational potential energy gained (E_{b}) and interfacial tension (Eₛ) are shown. A difference in energy may be given by ΔE=E_{b}−Eₛ. A shape transition occurs when ΔE is significantly greater than 0. Upward forces from lower droplets pushed up by buoyancy lead to deformation, while interfacial tension resists.

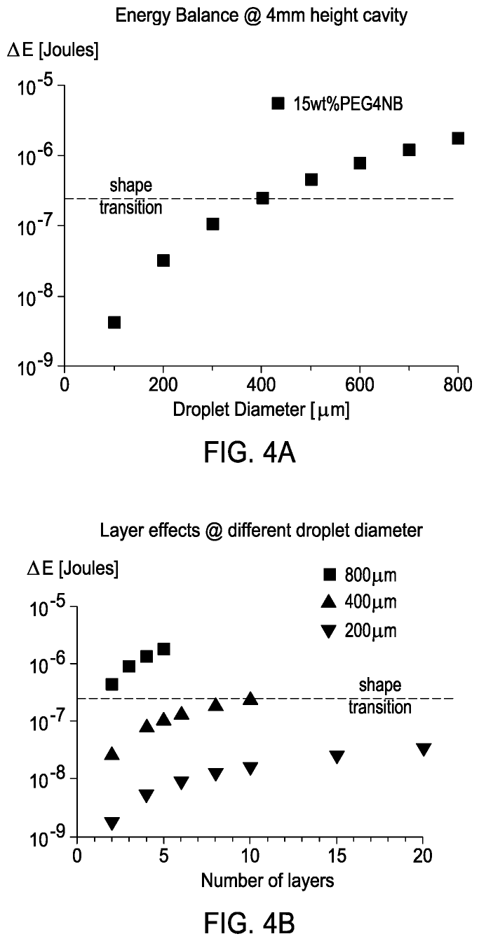

FIGS. 4A-4B show diameter effects. An energy difference between buoyancy and interfacial tension was determined, assuming a 4 mm tall cavity filled with maximal packing layers for each droplet size that can be generated. As shown in FIG. 4A, it was found that larger droplets (e.g., ≥400 m) underwent shape deformation (shape transition is indicated as a dotted line) and packed in polyhedral structures. This shift occurs at an energy difference of approximately 2.47×10⁻⁷ J.

Further, layer effects were investigated, as shown in FIG. 4B. How layering impacts energy difference (ΔE) for constant diameter droplets was calculated. At the same cavity height (4 mm), increasing the number of layers and droplet sizes increases the energy difference between forces. Shape transition is indicated as a dotted line. In certain aspects, these preliminary results help to determine the number of layers required to achieve shape deformation.

Droplet distribution and shape are investigated as follows. Images shown in FIGS. 1A-1C taken post-droplet generation show 15 wt. % PEG4NB gel droplets at an average size of 400 micrometers (μm) with approximately 62070 droplets in a 4 mm H×40 mm L×13 mm W cavity at a flow rate of 5 mL/hr. and low dispersity (PDI=0.001). See FIG. 1A. Fluorescent and bright-field images (FIGS. 1B and 1C) of post-swelled microgels confirmed the generation of polyhedral particles.

Further, the transition of shape of the microparticles was investigated. In a 4-mm-tall cavity, spherical droplets (approximately 400 micrometers (μm) diameter) transitioned to polyhedrons as packing layers increase from 2 layers (FIG. 1D) to 8 layers (FIG. 1E), indicating that the droplets are compressed against each other due to increased volume.

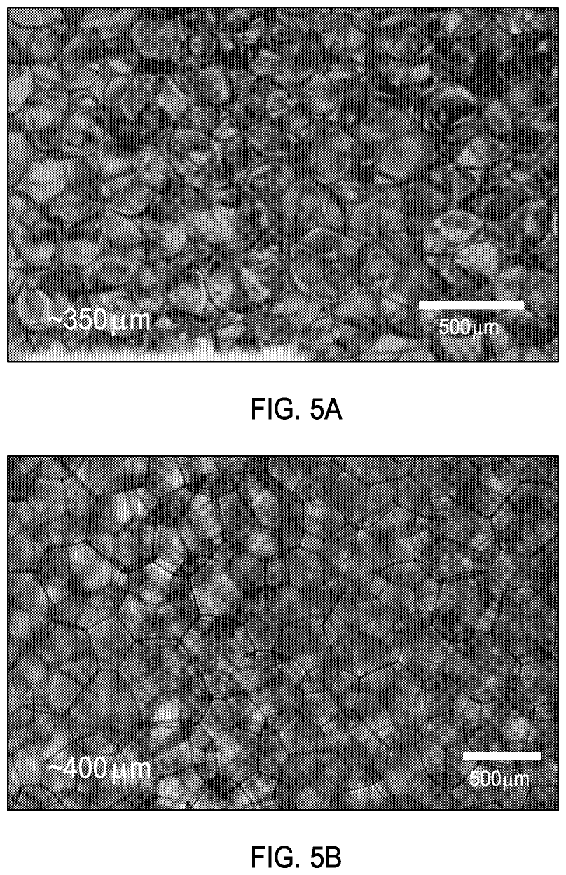

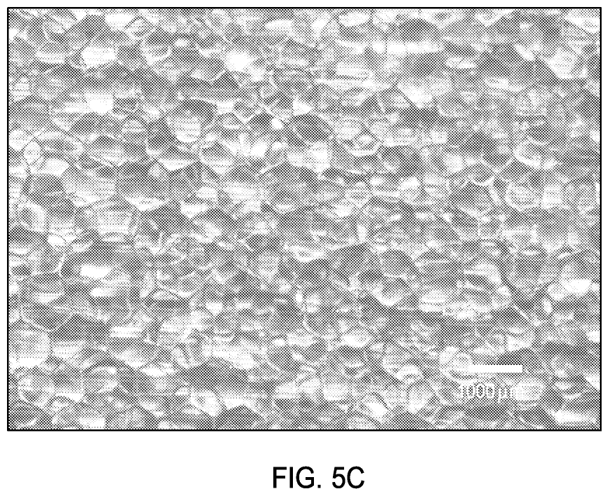

FIGS. 5A-5C show testing of average droplet diameters of 350 micrometers (μm) (FIG. 5A), 400 micrometers (FIG. 5B) and 1,000 micrometers (FIG. 5C) at a maximum of 10 layers. This reveals that droplets with a diameter of ≥400 μm shifted to polyhedral particles, emphasizing size-dependent transformation.

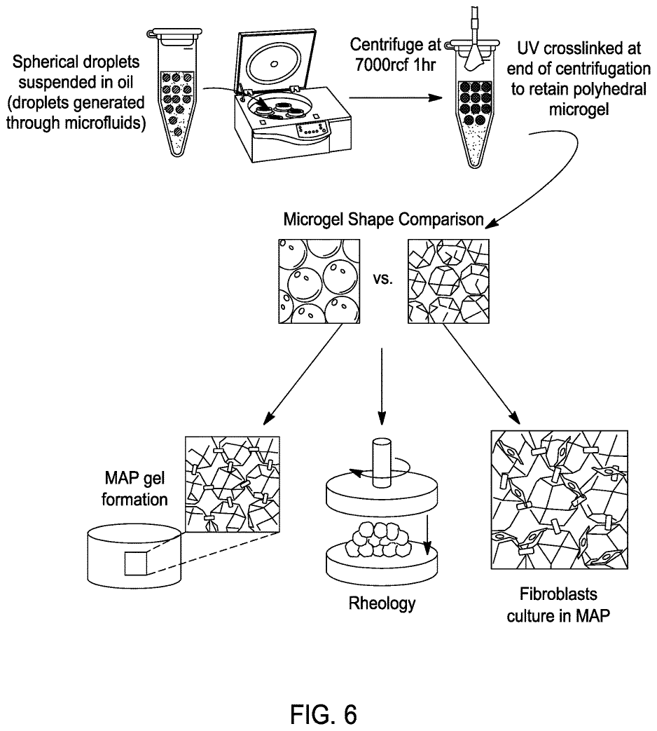

FIG. 6 shows a process according to certain aspects of the present disclosure for forming polyhedral microparticle containing microgels. More specifically, FIG. 6 shows a workflow for generating polyhedral microgels from spherical droplets and evaluating scaffold properties. First, spherical droplets were first generated through a microfluidic droplet generator (e.g., as described in FIGS. 2A-2C) and transferred to a centrifuge tube while suspended in oil. The spherical droplets were then subjected to a rotational separation process, in this case a high-speed centrifuge (7000 rcf for about 1 hour), to induce close packing and compression. Then, the close-packed microdroplets were subjected to a gelation reaction (e.g., UV crosslinked) at the end of centrifugation to retain the polyhedral geometry.

Polyethylene glycol norbornene (PEG-NB) spherical droplets (about 150 m to about 500 μm in diameter) were generated using a microfluidic droplet generator submerged in 0.4 wt. % Picosurf® in Novec™ 7500 and crosslinked via a UV-photoinitiated thiol-ene reaction. Polyhedral microgels were generated by packing spherical droplets and centrifuging (7000 rcf for 1 hr), followed by UV crosslinking at the end of centrifugation. Centrifugation provides a packing compression force across the multiple layers of microdroplets, as previously observed when droplets with multiple layers start pushing against each other (e.g., in FIGS. 1D and 1E) due to buoyancy and compression packing.

The microdroplets were comprised of 10 wt. % PEG-8-norbornene, crosslinked with PEG-dithiol via LAP-initiated photopolymerization (thiol-ene reaction). The microgels are then annealed into a MAP scaffold by adding PEG-dithiol (crosslinker) and lithium phenyl-2,4,6-trimethylbenzoylphosphinate (photoinitiator), with the reaction initiated with UV light.

Generally, crosslinking is a reaction between respective polymer chains within each microparticle to connect/crosslink them to one another. Annealing generally means that individual microgel particles/microbeads can be subjected to surface reactions and thus annealed and joined together to form a porous scaffold structure. For example, a PEG-dithiol (crosslinker) and a photo initiator (LAP) can be used to promote annealing to form a porous scaffold structure.

Normal Human Ventricular Cardiac Fibroblasts (NHCF-V, female) fibroblasts were cultured in MAP gels (mixed inside with the microgels) (containing 250 μM RGD and an additional 250 μM of RGD included during annealing) and fixed on days 1, 3, 5, 7, and 12. Fixed cells were stained with Hoechst (nuclei) and Phalloidin Alexa-Fluor (AF) 635 (F-actin).

Polyhedral and spherical microgels were compared for (i) microporous annealed microgel (MAP) scaffold formation and pore architecture, (ii) bulk mechanical properties through rheology, and (iii) cell responses assessed by fibroblasts morphology in MAP scaffolds. It was found that polyhedral microgel presents a new geometry class of MAP scaffold building blocks with distinct properties compared with spherical MAP (higher G′ and less porous). Fibroblasts also adopted a more elongated morphology in polyhedral MAP.

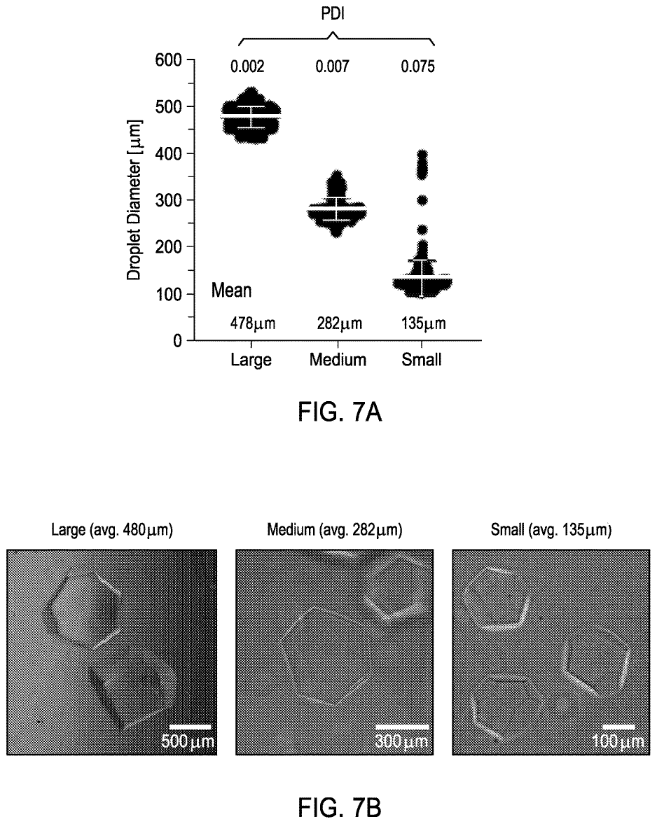

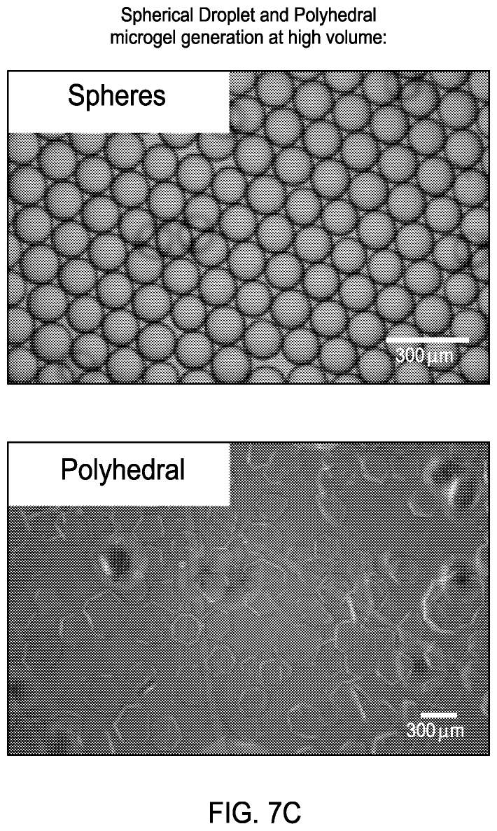

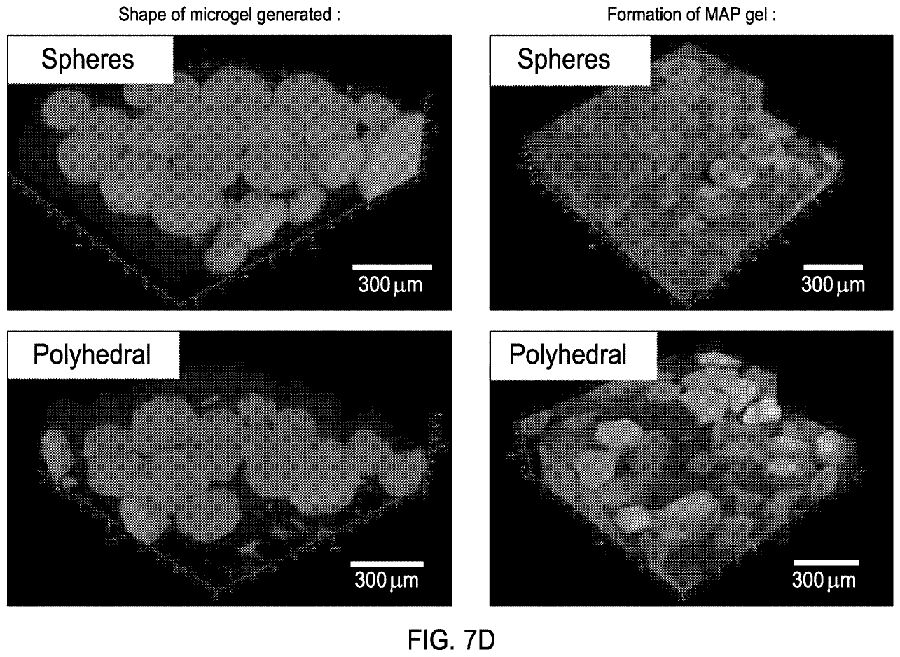

FIGS. 7A-7D show generation of polyhedral microgels across sizes and formation into MAP gel. Polyhedral microgels were formed using 10 wt. % Polyethylene glycol (PEG)-8-norbornene, crosslinked with PEG-dithiol via lithium phenyl-2,4,6-trimethylbenzoylphosphinate (LAP)-initiated photopolymerization (thiol-ene), as described above.

Droplet diameter distribution is shown for large, medium, and small spherical droplets (mean diameters: 480 micrometers (μm), 282 micrometers (μm), 135 micrometers (μm); where the PDI for each is listed. Representative brightfield images show polyhedral microgels of each size and high-volume production from spherical droplets. Confocal z-stack 3D-reconstructed images highlighted the transition from spherical microgels to polyhedral microgels. Microporous annealed microgel (MAP) gel formed from polyhedral microgels like those described above showed distinct microgel edges compared with spherical MAP.

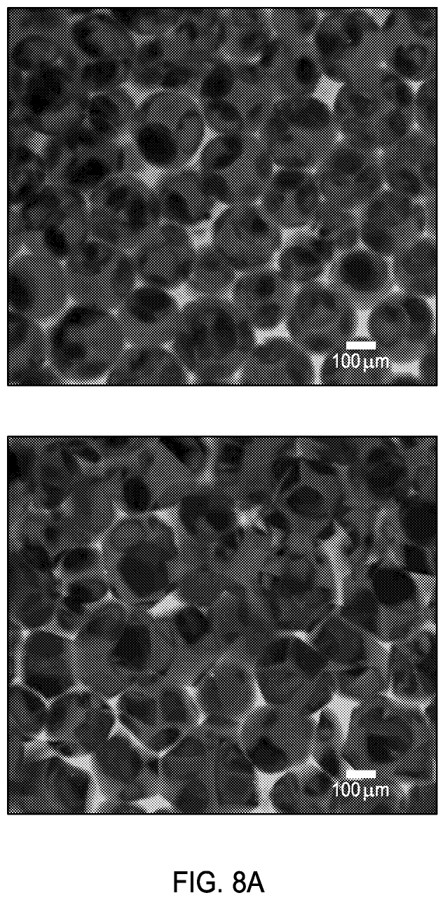

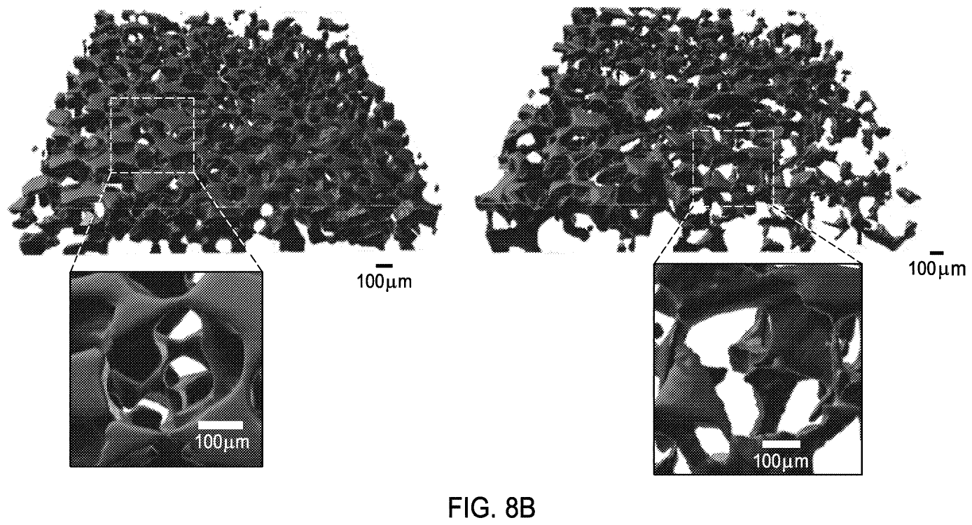

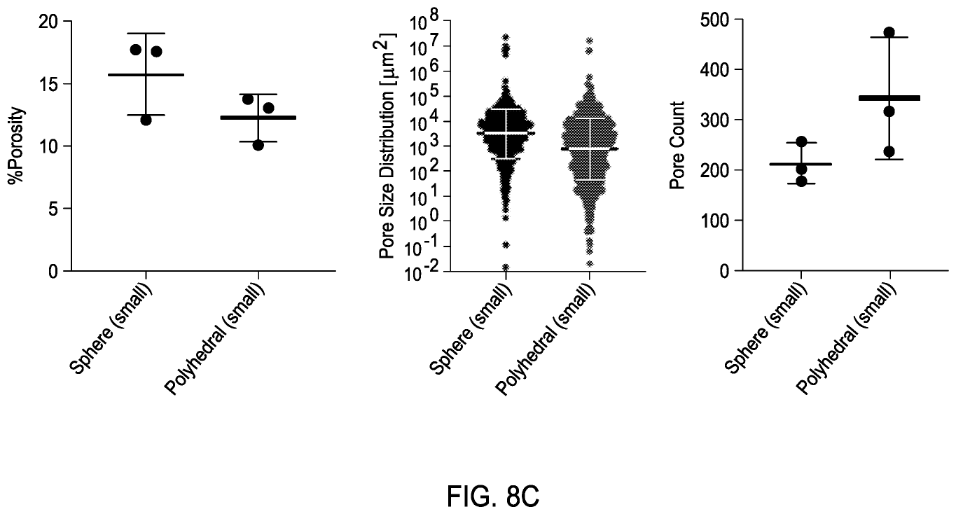

FIGS. 8A-8C show a comparison of polyhedral microgels prepared in accordance with certain aspects of the present disclosure versus spherical microgels. The polyhedrons here are formed using the same process and materials as described above. The conditions used to create annealed MAP are as follows: microdroplets are comprised of 10 wt. % PEG-8-norbornene, crosslinked with PEG-dithiol via LAP-initiated photopolymerization (thiol-ene reaction). The microgels are then annealed into a MAP scaffold by adding PEG-dithiol (crosslinker) and lithium phenyl-2,4,6-trimethylbenzoylphosphinate (photoinitiator) with the reaction initiated with UV light. FIGS. 8A-8C demonstrate that polyhedral microgels alter MAP scaffold pore architecture compared to spherical microgels. MAP scaffolds were assembled with a matched volume of spherical or polyhedral microgels (post-swelling, about 250 μm in diameter). Porosity, pore count, and pore size distribution were quantified from confocal z-stack spanning 400 micrometers (μm) in z-depth (n=3 scaffolds per shape, mean±s.d.) in IMARIS software. Polyhedral scaffolds showed lower overall porosity, higher pore count, and a shift towards smaller pores compared to spherical scaffolds.

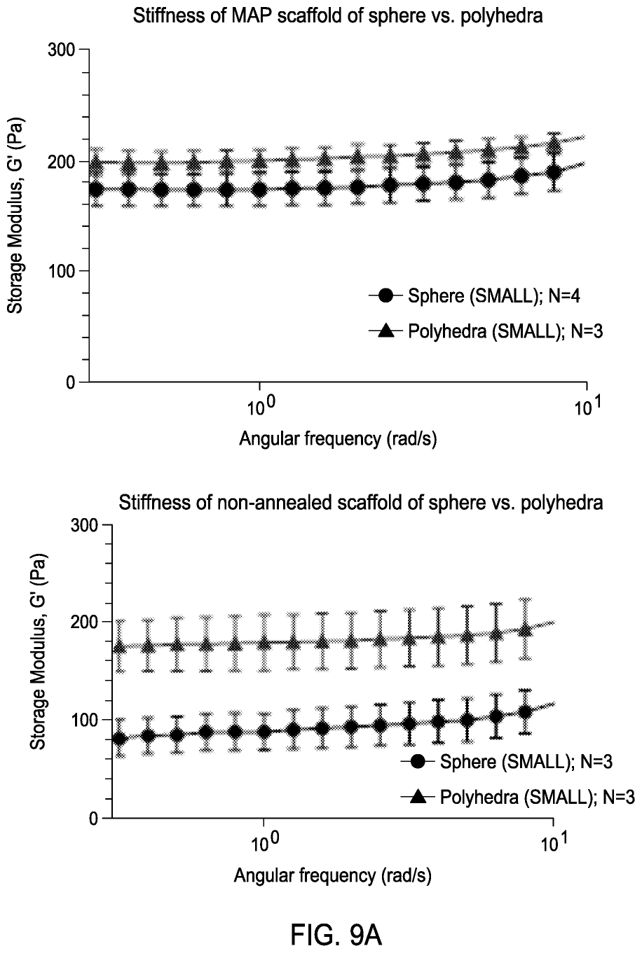

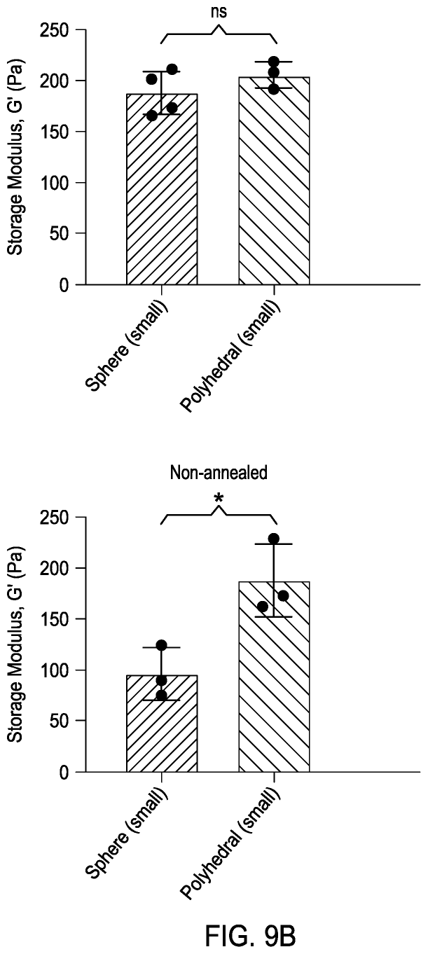

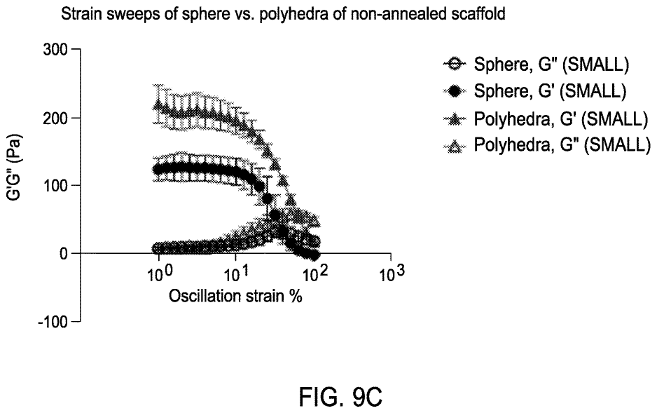

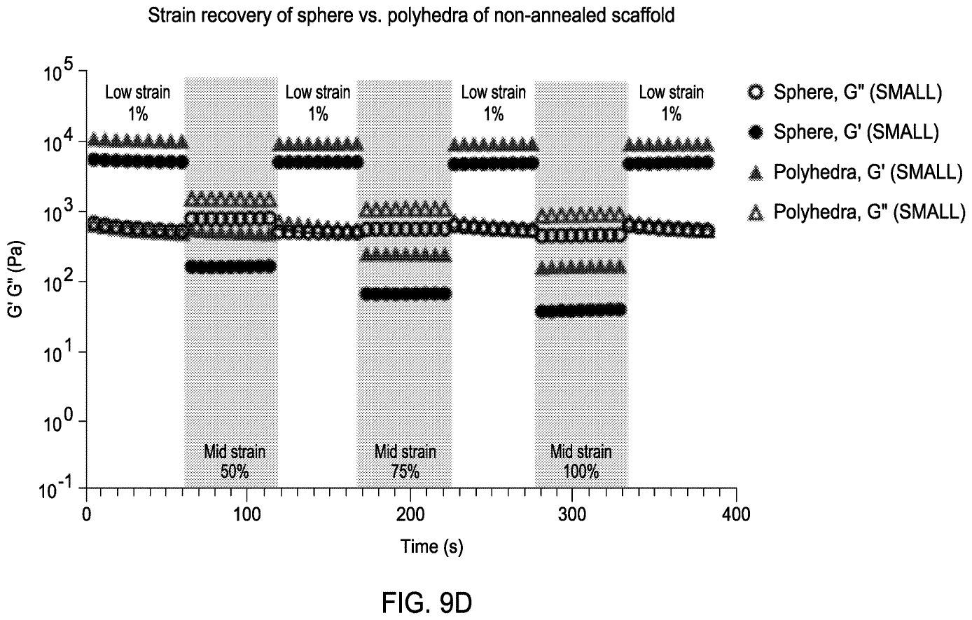

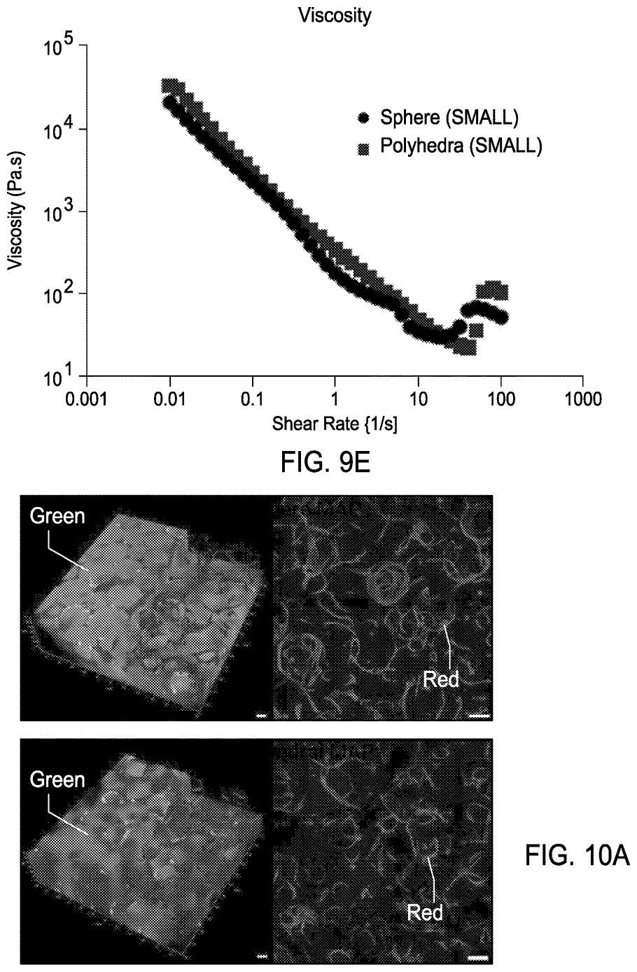

FIGS. 9A-9E show rheological comparison of spherical and polyhedral scaffolds prepared in accordance with certain aspects of the present disclosure. Storage modulus (G′) was measured for spherical and polyhedral scaffolds under annealed (MAP) and non-annealed states (n=3, mean±s.d.). The conditions used to create the annealed MAP: the microdroplets were comprised of 10 wt. % PEG-8-norbornene, crosslinked with PEG-dithiol via LAP-initiated photopolymerization (thiol-ene reaction) so that they become crosslinked microgels. The microgels are then annealed into a MAP scaffold by adding PEG-dithiol (crosslinker) and lithium phenyl-2,4,6-trimethylbenzoylphosphinate (photoinitiator) with the reaction initiated with UV light (the microgels are first centrifuged (at 10,000×g) to be packed then the crosslinker and photoinitiator are added into this microgel solution, so that the individual microgels can anneal together so that they become one porous scaffold structure (the microgels are now the building block for a scaffold).

The non-annealed microgels were centrifuged (spun down) at 10,000×g for 5 minutes, and the supernatant was removed to create a concentrated granular gel solution. About 50 μL of microgel is pipetted onto a parallel plate on the rheometer for rheological measurements. See FIGS. 9A-9B. Under the non-annealed state, polyhedral scaffolds exhibited a higher storage modulus (G′) than spherical scaffolds, consistent with shape-driven differences in scaffold architecture (higher pore count but smaller pores). Under MAP annealing, spherical and polyhedral MAP gels showed comparable G′ with spherical MAP gels. FIGS. 9C and 9D show strain recovery of spheres versus polyhedra of non-annealed scaffold (FIG. 9C shows oscillation strain (%) versus storage modulus and loss modulus (G′ G″ (Pa)) and FIG. 9D shows time (second) versus storage modulus and loss modulus (G′ G″ (Pa)))), where Thixotropy tests (non-annealed) show comparable strain recovery for both shapes, supporting injectability, while polyhedral scaffolds remained stiffer overall while viscosity tests (non-annealed) in FIG. 9E show comparable viscosity for both shapes and shear-thinning behavior relevant to injectability. p*<0.05, ns=not significant.

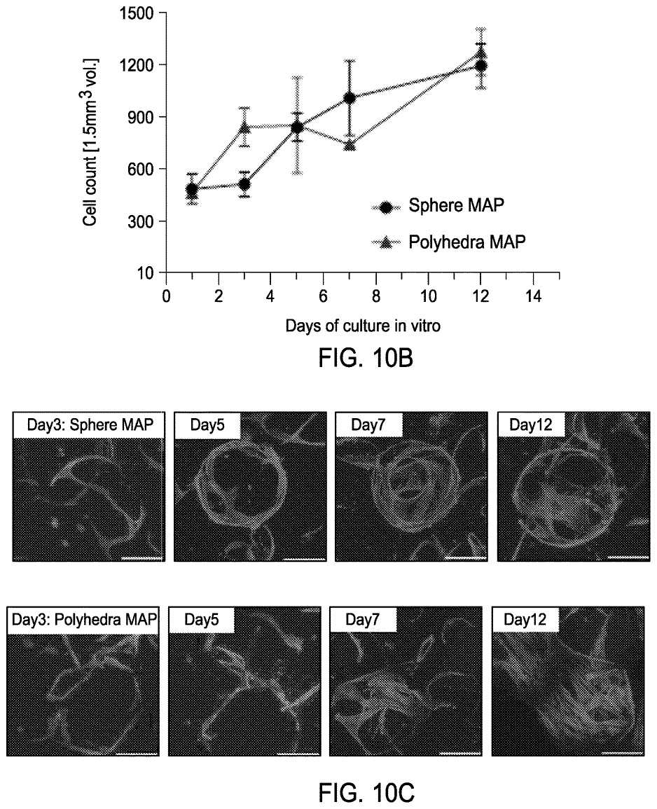

FIGS. 10A-10C show microgel shape influences NHCF-V morphology and cell accumulation in MAP scaffolds. Normal Human Ventricular Cardiac Fibroblasts (NHCF-V) fibroblasts were cultured for 12 days on spherical and polyhedral MAP scaffolds containing RGD peptide for enhancing cell adhesion. MAP gel was first prepared by adding PEG-dithiol (crosslinker), RGD (attachment peptide), and lithium phenyl-2,4,6-trimethylbenzoylphosphinate (photoinitiator) to concentrated microgels in a centrifuge tube. Cell solution (a mixture of cells and cell culture media) of a known concentration (2 k cells/microliter of gel) was also mixed into the MAP gel solution containing peg-DT, RGD, and LAP. Once well mixed, where the cells and microgels are distributed, a volume (20 microliters) was pipetted out and crosslinked under UV light.

As shown in FIG. 10A, fibroblasts in polyhedral MAP adopted a more elongated, linear morphology compared with fibroblasts on spherical MAP, which tend to wrap around the curvature of microgels. This suggests that microgel geometry (curvature in the spherical microgel versus edges and flat faces in the polyhedral microgel) and associated pore architecture can influence cell morphology and organization. FIG. 10B shows days of culture in vitro versus cell count in comparative hydrogels. Cell counts over time were quantified from Hoechst-stained nuclei (n=3, mean±s.d). Nuclei: Hoechst (blue) nuclei and F-actin: Phalloidin AF635 (red) stain. Representative images are shown in FIG. 10C across culture time points (ranging from 3 to 12 days).

In providing the capability of making polyhedron microgels, new microgel scaffold structures made from distinct geometries are possible, which can be studied for different cellular responses, creating new pathways to investigate geometric effects on biological behavior. In certain aspects, the methods may be conducted as batch processes to form uniform polyhedral particles using buoyancy-driven forces and droplet deformation from layer-to-layer packing for polyhedral microgels, leading to a high production volume of such templated gels. Further, the role of buoyancy forces, interfacial tension, and droplet packing for droplet compression to demonstrate the efficiency of batch-produced polyethylene glycol (PEG) polyhedral microgels are being investigated. After polyhedral particles are formed, the final microgels are polymerized through photoinitiation of the thiol-ene click chemistry. For example, UV exposure at 365 nm can be conducted before removing microgels/microparticles from a reservoir where they are collected after formation.

It has been observed that monodispersed emulsions in a confined space, exhibit highly ordered structures as the oil phase is evaporated and leads to polyhedral droplets. Here, the particles are first generated with flow through parallelized outlet channels in a microdroplet generator and then transported into a static confined reservoir pre-filled with a heavy density oil and surfactants.

In certain aspects, the method for generating microparticles having a polyhedral shape for a microgel include generating a plurality of microdroplets. The generating may occur by introducing a precursor solution into an inlet of a component that comprises a plurality of channels in fluid communication with a plurality of outlets. The precursor solution flows radially through the component from the inlet to the plurality of outlets and passes into a fluid contained in a fluid reservoir to generate a plurality of microdroplets that transition into a plurality of microparticles having a polyhedral shape. The precursor solution has a first density, the fluid has a second density distinct from the first density, and at least one of the precursor solution or fluid comprises a surfactant. The method may further comprise conducting a gelation process on the plurality of microparticles in a receptacle to form a microgel. The plurality of microdroplets may be collected in a receptacle and may define a plurality of distinct layers of the microdroplets.

In one aspect, the precursor solution comprises a crosslinker comprising a thiol group. The precursor solution may comprise a polymeric precursor of a polymeric backbone selected from the group consisting of: hyaluronic acid, polyalkylene glycol, such as polyethylene glycol, alginate, gelatin, trehalose, and combinations thereof. The polymeric backbone may further have a functional group selected from the group consisting of: norbornene, maleimide, acrylate, and combinations thereof.

In one aspect, the precursor solution comprises a polymeric precursor selected from the group consisting of: hyaluronic acid-norbornene, polyethylene glycol-norbornene, polyethylene glycol-maleimide, polyethylene glycol-di-acrylate, and combinations thereof.

In one aspect, the plurality of microdroplets has an average diameter of greater than or equal to about 135 micrometers. For example, the plurality of microparticles may have an average particle size of greater than or equal to about 135 micrometers to less than or equal to about 1,000 micrometers in certain variations.

In certain aspects, the second density of the fluid is greater than the first density of the precursor solution and the fluid comprises an oil. The fluid may further comprise the surfactant(s) in certain aspects. In one aspect, the surfactant is a nonionic surfactant.

The polyhedral shape is selected from the group consisting of: rectangular prism, cube, pyramid, tetrahedron, pentahedron, hexahedron, heptahedron, octahedron, decahedron, undecahedron, dodecahedron, icosahedrons, prismatoids, and combinations thereof.

In one aspect, after the generating, the method further comprises centrifuging the plurality of microdroplets to facilitate the transition to the plurality of microparticles having a polyhedral shape.

With increased layers and reduced interfacial tension, the droplets shift from spheres to sharp-edge polyhedrons when packed together in the cavity. This method allows high throughput production and passive templating of polyhedral microgels. Granular gels with distinct geometries have shown different cellular responses in 3D scaffolds with cells within the pore structure for tissue engineering. Further, different pore structures and void spaces can advantageously provide guidance cues for cell expansion, formation of paths of least resistance to guide cell invasion and migration, and influence cell infiltration when compared to spherical particles.

The present disclosure contemplates a simple and high-throughput generation method for polyhedral microgels from polyhedral microparticles, leading to a high production volume of these templated gels.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A microparticle defining a polyhedral shape and comprising a polymeric precursor and a crosslinking agent capable of undergoing a gelation reaction to form a cross-linked polymeric microgel.

2. The microparticle of claim 1, wherein the polymeric precursor is of a polymeric backbone selected from the group consisting of: hyaluronic acid, polyalkylene glycol, alginate, gelatin, trehalose, and combinations thereof.

3. The microparticle of claim 1, wherein the polymeric precursor is selected from the group consisting of: hyaluronic acid-norbornene, polyethylene glycol-norbornene, polyethylene glycol-maleimide, polyethylene glycol-di-acrylate, and combinations thereof.

4. The microparticle of claim 1, wherein the crosslinking agent comprises a thiol group.

5. The microparticle of claim 1, wherein the crosslinking agent is selected from the group consisting of: a dithiothreitol crosslinking agent, a polyethylene-glycol dithiol crosslinking agent, an enzymatically degradable plasmin-sensitive YKNS crosslinking agent, and combinations thereof.

6. The microparticle of claim 1, wherein the polymeric precursor further comprises a functional group or moiety selected from the group consisting of: norbornene, maleimide, cyclononane, bicyclononyne, dibenzocyclooctyne (DBCO), dibenzoazacyclooctyne (DIBAC), vinyl sulfone, azide, tetrazine, acrylate, methacrylate, and combinations thereof.

7. The microparticle of claim 1 has an average particle size of greater than or equal to about 400 micrometers to less than or equal to about 1,000 micrometers.

8. The microparticle of claim 1, wherein the polyhedral shape is selected from the group consisting of: rectangular prism, cube, pyramid, tetrahedron, pentahedron, hexahedron, heptahedron, octahedron, decahedron, undecahedron, dodecahedron, icosahedrons, prismatoids, and combinations thereof.

9. A method for generating microparticles having a polyhedral shape for a microgel, the method comprising:
generating a plurality of microdroplets by introducing a precursor solution into an inlet of a component that comprises a plurality of channels in fluid communication with a plurality of outlets, wherein the precursor solution flows radially through the component from the inlet to the plurality of outlets and passing into a fluid contained in a fluid reservoir to generate the plurality of microdroplets that transition into a plurality of microparticles having a polyhedral shape, wherein the precursor solution has a first density, the fluid has a second density distinct from the first density, and at least one of the precursor solution or fluid comprises a surfactant.

10. The method of claim 9, further comprising conducting a gelation process on the plurality of microparticles in a receptacle to form the microgel.

11. The method of claim 9, wherein the plurality of microdroplets are collected in a receptacle to define a plurality of distinct layers of the microdroplets.

12. The method of claim 9, wherein the precursor solution comprises a crosslinker comprising a thiol group.

13. The method of claim 9, wherein the precursor solution comprises a polymeric precursor of a polymeric backbone selected from the group consisting of: hyaluronic acid, polyalkylene glycol, alginate, gelatin, trehalose, and combinations thereof, the polymeric backbone further having a functional group selected from the group consisting of: further comprises a functional group or moiety selected from the group consisting of: norbornene, maleimide, cyclononane, bicyclononyne, dibenzocyclooctyne (DBCO), dibenzoazacyclooctyne (DIBAC), vinyl sulfone, azide, tetrazine, acrylate, methacrylate, and combinations thereof.

14. The method of claim 9, wherein the precursor solution comprises a polymeric precursor selected from the group consisting of: hyaluronic acid-norbornene, polyethylene glycol-norbornene, polyethylene glycol-maleimide, polyethylene glycol-di-acrylate, and combinations thereof.

15. The method of claim 9, wherein the plurality of microdroplets has an average diameter of greater than or equal to about 135 micrometers.

16. The method of claim 9, wherein the plurality of microparticles has an average particle size of greater than or equal to about 135 micrometers to less than or equal to about 1,000 micrometers.

17. The method of claim 9, wherein the second density of the fluid is greater than the first density of the precursor solution and the fluid comprises an oil.

18. The method of claim 9, wherein the polyhedral shape is selected from the group consisting of: rectangular prism, cube, pyramid, tetrahedron, pentahedron, hexahedron, heptahedron, octahedron, decahedron, undecahedron, dodecahedron, icosahedrons, prismatoids, and combinations thereof.

19. The method of claim 9, wherein the surfactant is a nonionic surfactant.

20. The method of claim 9, wherein after the generating, the method further comprises centrifuging the plurality of microdroplets to facilitate the transition to the plurality of microparticles having the polyhedral shape.
